(19) United States
(12) Patent Application Publication
(10) Pub. No.: US 2008/0247114 A1
(43) Pub. Date: Oct. 9, 2008

(54) Method for removing static electricity from a plate

(76) Inventors: Jong-mo Yeo, Suwon-si (KR); Soo-beom Jo, Suwon-si (KR); Sung-won Doh, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/073,504

(22) Filed: Mar. 6, 2008

(30) Foreign Application Priority Data
Apr. 6, 2007 (KR) 10-2007-0034099

(51) Int. Cl. H05F 3/00

(52) U.S. Cl. 361/220

(57) ABSTRACT

A method for removing static electricity from a first plate in a processing chamber including a substrate on the first plate and a second plate opposite the first plate, the method includes generating static electricity in the first plate to adhere the substrate to the first plate, and supplying argon gas into the processing chamber to remove the static electricity.

### BACKGROUND OF THE INVENTION

1. Field of the Invention

Embodiments of the present invention relate to a method for removing a substrate from a holding plate. More specifically, embodiments of the present invention relate to a method for removing static electricity securing a substrate to a holding plate.

2. Description of the Related Art

Generally, formation of films on a substrate may include a series of processes, e.g., exposure, etching, diffusion, deposition, and so forth. In order to perform the above mentioned processes, the substrate may be loaded into and/or unloaded from a holding plate of a processing chamber. For example, the substrate may be fixed onto a holding plate in a processing chamber, e.g., a plasma device, followed by deposition and/or etching of a film thereon. The substrate may be fixed to the holding plate via, e.g., a mechanical clamping device. A method of detaching the substrate from the holding plate without damaging the substrate may be determined with respect to the fixing method thereof.

Attempts have been made to fix a substrate to a holding plate by generating static electricity therebetween. However, conventional methods of removing the static electricity to separate the substrate from the holding plate may contaminate and/or damage the substrate and/or thin film layers formed thereon. Accordingly, there exists a need for a method for removing a substrate secured to a holding plate without damaging and/or contaminating the substrate and/or layers thereon.

### SUMMARY OF THE INVENTION

Embodiments of the present invention are therefore directed to a method for removing a substrate from a holding plate, which substantially overcomes one or more of the disadvantages of the related art.

It is therefore a feature of an embodiment of the present invention to provide a method for removing static electricity securing a substrate to a holding plate.

At least one of the above and other features and advantages of the present invention may be realized by providing a method for removing static electricity from a first plate in a processing chamber including a substrate on the first plate and a second plate opposite the first plate, the method including generating static electricity in the first plate to adhere the substrate to the first plate, and supplying argon gas into the processing chamber to remove the static electricity. Generating static electricity may include applying voltage to the first plate. Generating static electricity may include using an electrostatic chuck as a first plate.

The method may further include processing the substrate on the first plate after adhering the substrate thereto. Processing the substrate on the first plate may include forming at least one thin film thereon. Forming the thin film may include depositing silver or silver alloy on the substrate. Processing the substrate on the first plate may further include etching the thin film by using plasma. Processing the substrate on the first plate may include forming silver or silver alloy electrodes thereon. The method may further include detaching the substrate from the first plate by raising a lift pin through the first plate after removing the static electricity from the first plate. The method may further include removing the substrate from the processing chamber after removing the static electricity from the first plate.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic cross-sectional view of a processing apparatus;

FIGS. 2A-2F illustrate cross-sectional views of sequential stages in a method for removing static electricity from a holding plate according to an embodiment of the present invention;

FIG. 3 illustrates a block diagram of a method for removing static electricity from a holding plate according to an embodiment of the present invention;

FIGS. 4A-4B illustrate scanning electron microscope (SEM) photographs of source/drain electrodes of a TFT formed according to Comparative Example 1;

FIGS. 5A-5B illustrate SEM photographs of source/drain electrodes of a TFT formed according to Example 1;

FIG. 6 illustrates a cross-sectional view of a thin film transistor formed on a substrate in the processing chamber of FIG. 1;

FIG. 7 illustrates a cross-sectional view of an electroluminescent display formed in the processing chamber of FIG. 1.

### DETAILED DESCRIPTION OF THE INVENTION

Korean Patent Application No. 10-2007-0034099, filed on Apr. 6, 2007, in the Korean Intellectual Property Office, and entitled: “Method for Removing Residual Charge From Electro Static Plate,” is incorporated by reference herein in its entirety

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

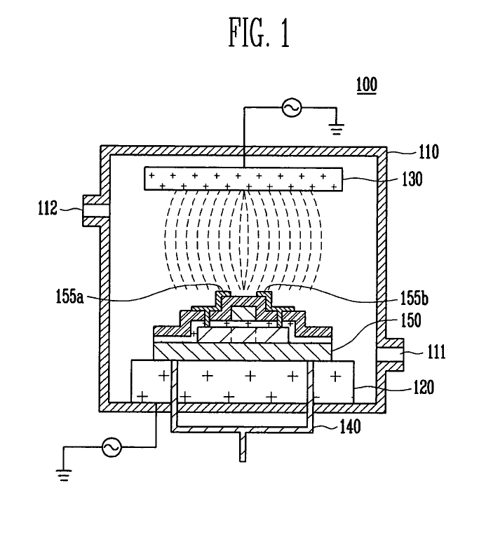

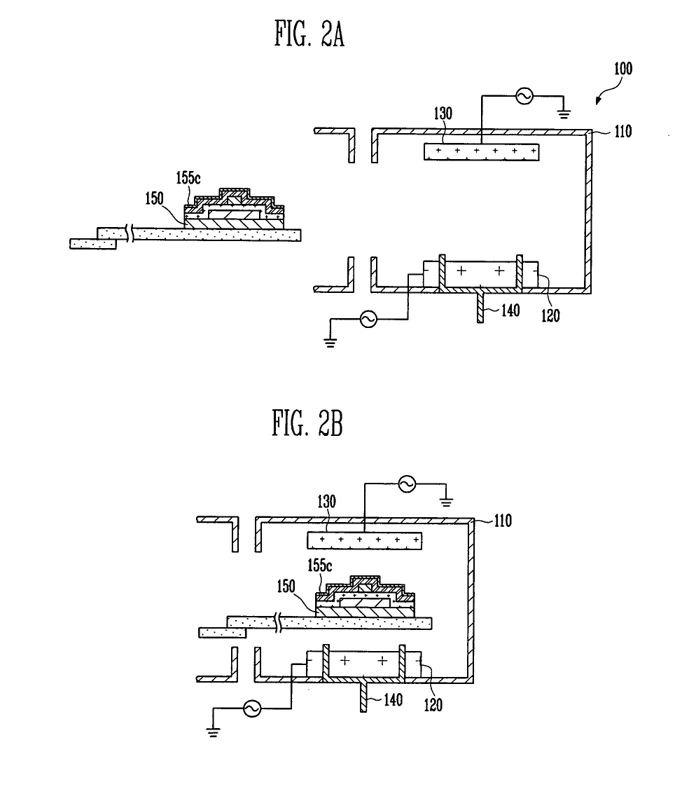

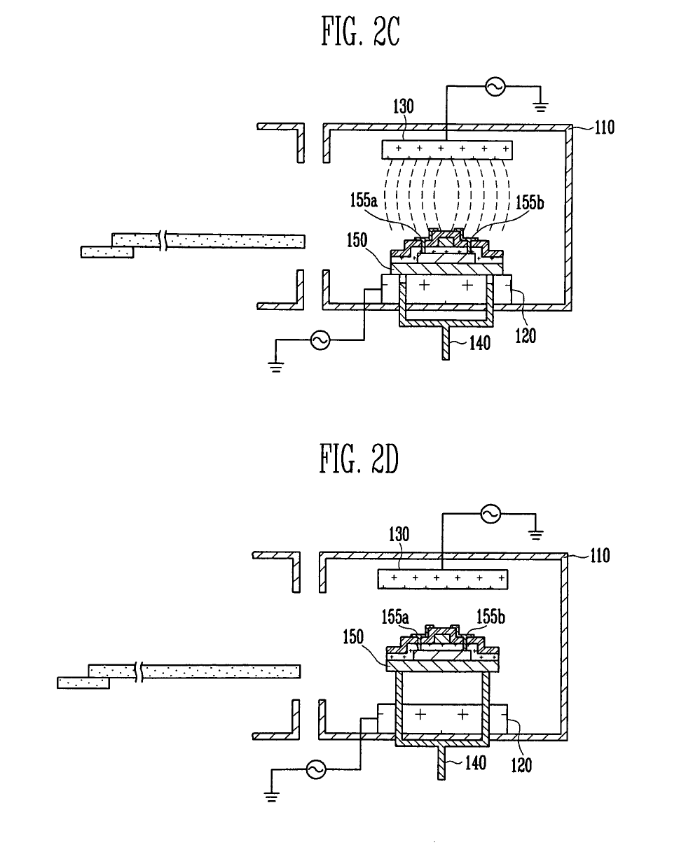

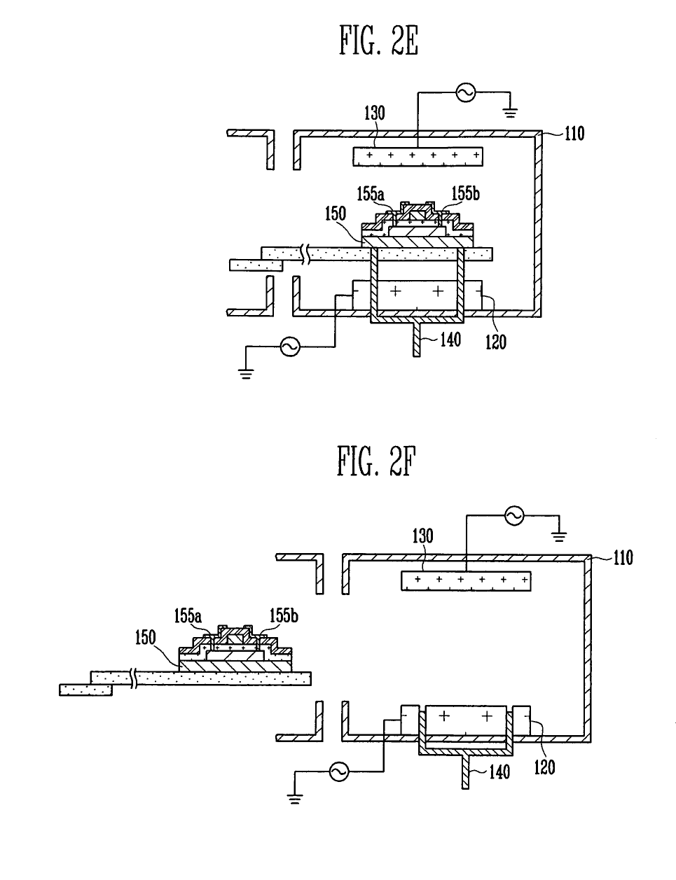

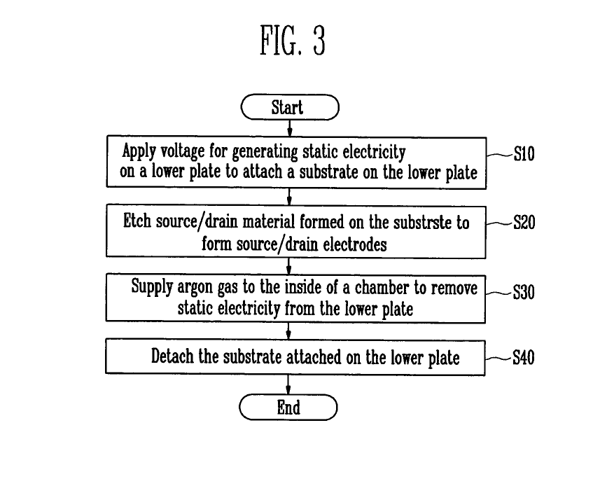

Hereinafter, a method for removing a substrate from a holding plate in a processing chamber according to an exemplary embodiment of the present invention will be described in more detail below with reference to FIGS. 1-3. FIG. 1 illustrates a schematic cross-sectional view of a processing apparatus used for processing a substrate according to an embodiment of the present invention, and FIGS. 2A-2F and 3 illustrated a method for removing a substrate from the processing apparatus of FIG. 1.

As illustrated in FIG. 1, a processing apparatus 100, e.g., a device for etching wafers using plasma, may include a chamber 110 with lower and upper plates 120 and 130. The lower and upper plates 120 and 130 may be parallel and opposite each other in the chamber 110, and each of the lower and upper plates 120 and 130 may be electrically connected to an external voltage supply. The processing apparatus 100 may further include a lift pin 140 in the chamber 110. The lift pin 140 may be in the lower portion of the chamber 110, and may protrude through the lower plate 120, as further illustrated in FIG. 1. The lift pin 140 may move vertically to extend above the lower plate 120.

A substrate 150 may be inserted into the chamber 110, and may be positioned on the lower plate 120 for processing, e.g., a thin film deposition and/or etching. More specifically, the lift pin 140 may be raised above the lower plate 120 to support the substrate 150 upon insertion into the chamber 110. Then, the lift pin 140 may be lowered to align with an upper surface of the lower plate 120, so that the substrate 150 may be positioned on the upper surface of the lower plate 120. Static electricity may be generated in the lower plate 120, e.g., via application of voltage thereto by way of the voltage supply, to facilitate stronger attachment between the substrate 150 and the lower plate 120. The lower plate 120 may be an electrostatic chuck to facilitate uniform electrostatic forces between the lower plate 120 and the substrate 150. The upper surface of the lower plate 120 may be in complete contact with the substrate 150 because the electric field therebetween may produce strong clamping forces to chuck the substrate 150.

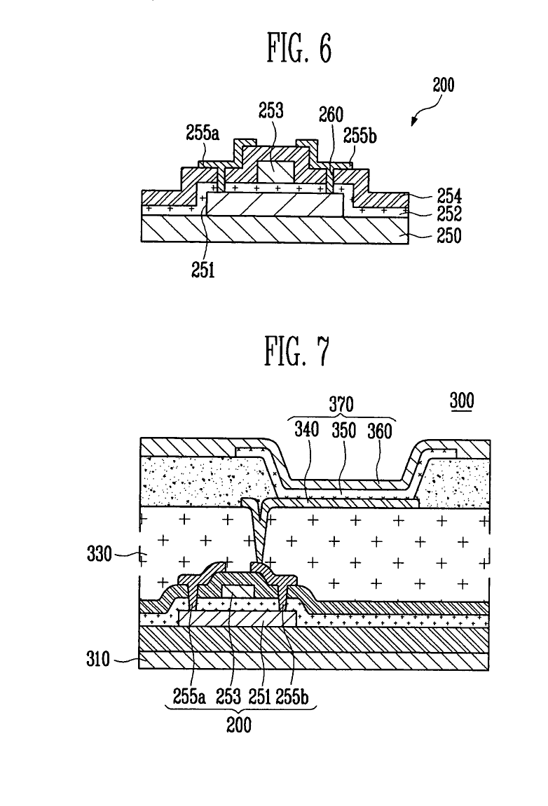

Once the substrate 150 is positioned securely and accurately on the lower plate 120, the substrate 150 may be processed. For example, a thin film transistor (TFT) may be formed on the substrate 150 by sequentially applying a semiconductor layer, an insulating layer, a gate electrode, and an inter-insulating layer, as will be discussed in more detail below with reference to FIG. 6. Source/drain materials, e.g., a silver (Ag) layer, may be deposited on the substrate 150 to form source/drain electrodes 155a and 155b by, e.g., plasma etching, as further illustrated in FIG. 1. Alternatively, a plurality of thin films may be deposited on the substrate 150 in a separate processing chamber, so the substrate 150 with the plurality of thin films thereon may be secured onto the lower plate 120 of the chamber 110 for etching, e.g., patterning the source/drain materials to form the source/drain electrodes 115a and 155b. Once processing of the substrate 150 is complete, the substrate 150 may be removed from the chamber 110. More specifically, the substrate 150 may be detached from the lower plate 120 by removing the static electricity therebetween, as will be discussed in more detail below with respect to FIGS. 2A-2F and 3, and may be raised by the lift pin 140 to be removed from the chamber 110. The chamber 110 may include gas inlet and outlet portions 111 and 112, respectively.

As illustrated in FIG. 2A, each of the upper and lower plates 130 and 120 of the processing apparatus 100 may be connected to a respective voltage supply. If the processing apparatus 100 is used for etching, the upper plate 130 may be connected to an RF power supply to form a plasma field in the chamber 110. The lift pin 140 may be lifted to support the substrate 150. If a plurality of films is deposited on the substrate 150 in a separate processing chamber, as illustrated in FIG. 1, the substrate 150 with the plurality of films thereon, i.e., a plurality of thin films including a conductive layer 1 55c, may be transferred into the chamber 110 to be supported by the lift pin 140, as illustrated in FIG. 2B.

Next, as illustrated in FIG. 2C, the lift pin 140 may be lowered to align with the lower plate 120, so the substrate 150 may be positioned in contact with the upper surface of the lower plate 120. Once the substrate 150 is placed on the lower plate 120, voltage may be applied to the lower plate 120 to generate static electricity therein, i.e., step S10 in FIG. 3, thereby enhancing adhesion between the substrate 150 and the lower plate 120. When the substrate 150 is secured onto the lower plate 120, processing thereof may begin, e.g., deposition and/or etching of films.

For example, a plurality of films may be deposited on the substrate 150, so that an upper film is, e.g., a silver layer or a silver alloy layer, followed by etching thereof to form a TFT with drain/source electrodes 155a and 155b. Alternatively, if the substrate 150 includes films thereon upon insertion into the chamber 110, etching of the films may be performed via, e.g., plasma, as illustrated in FIG. 2C. For example, an etching gas, e.g., chlorine (Cl) or fluorine (F), may be injected into the chamber 110, so the plasma field generated in the chamber 110 by the upper plate 130 may excite the etching gas to a sufficiently high energy level to facilitate etching of the conductive layer 155c to form source/drain electrodes 155 in the TFT, as further illustrated in FIG. 2C and step S20 of FIG. 3. The etching gas may etch a predetermined area of the source/drain layer 155c via, e.g., a chemical reaction and/or a collision reaction between molecules of the conductive layer 155c and the plasma field.

Thereafter, the static electricity between the substrate 150 and the lower plate 120 may be removed to facilitate separation of the substrate 150 from the lower plate 120. In detail, the voltage supply may be disconnected from the lower plate 120, and residual static electricity may be removed from the chamber 110 via gas flow. In further detail, a flow of argon (Ar) gas may be input into the chamber 110, e.g., through the gas inlet 111 of FIG. 1, at a flow rate of about 200 standard cubic centimeter per minute (sccm) to about 1000 sccm for at least about 30 minutes to remove residual static electricity between the lower plate 120 and the substrate 150, as indicated in step S30 of FIG. 3. Once the static electricity between the lower plate 120 and the substrate 150 is removed, the adhesive forces therebetween may be lowered, thereby facilitating separation therebetween. Once the substrate 150 is not fixed to the lower plate 120 by static electricity, the lift pin 140 may be raised above the lower plate 120 to detach the substrate 150 therefrom, as illustrated in FIG. 2D and step S40 of FIG. 3, to facilitate removal of the substrate 150 out of the chamber 110, as illustrated in FIG. 2E-2F.

### EXAMPLES

### Example 1

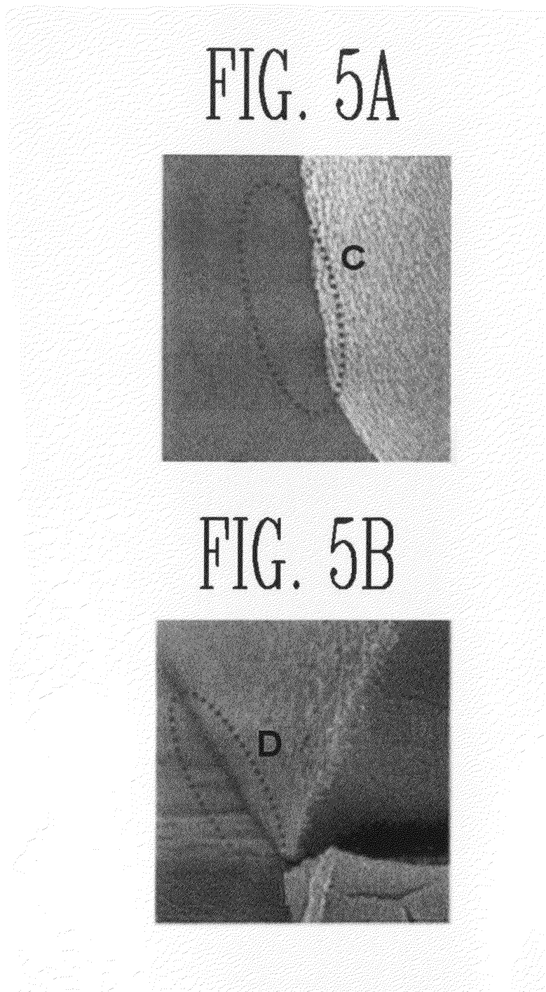

source/drain electrodes were formed of silver in a TFT according to an embodiment of the present invention. A scanning electron microscope (SEM) photograph was taken of the electrodes' surfaces, as illustrated in FIGS. 5A-5B.

### Comparative Example 1

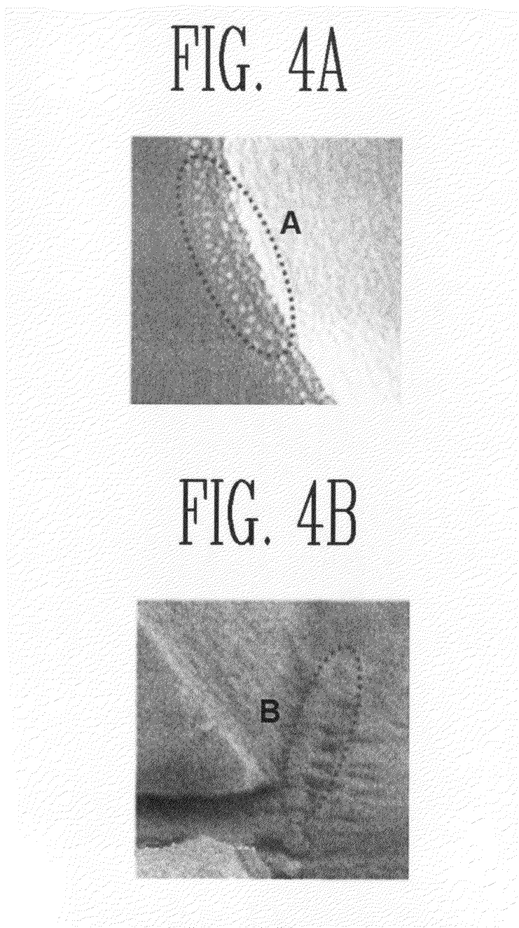

source/drain electrodes were formed of silver in a TFT in a substantially similar processing apparatus as the apparatus of Example 1, with the exception of using oxygen gas, instead of argon gas, to remove residual static electricity between the lower plate of the apparatus and the substrate of the TFT. A SEM photograph was taken of the electrodes' surfaces, as illustrated in FIGS. 4A-4B.

As can be seen in FIGS. 5A-5B, regions “C” and “D” in FIGS. 5A-5B, respectively, illustrate uniform surfaces of the source/drain electrodes. On the other hand, regions “A” and “B” illustrated in FIGS. 4A-4B, respectively, exhibit swollen and non-uniform surfaces.

Accordingly, removal of static electricity according to an embodiment of the present invention, i.e., via flow of an argon gas, may be advantageous in providing uniform thin film processing, while exhibiting minimized damage and contamination thereto. In other words, use of a noble gas, such as an argon, may prevent chemical interaction between the material of the thin film being processed, e.g., silver or silver alloy, and the noble gas, thereby providing uniform thin film formation. Use of oxygen, for example, may trigger chemical interaction between, e.g., the silver and the oxygen, thereby distorting formation and/or processing of the thin film, which in turn may reduce, e.g., operability of the TFT.

A thin film transistor (TFT) 200 may be formed in the processing apparatus 100 according to an embodiment of the present invention. More specifically, as illustrated in FIG. 6, the TFT 200 may include a semiconductor layer 251, a gate electrode 253, and source/drain electrodes 255a and 255b on a substrate 250. One or more of the layers of the TFT 200 may be deposited and/or etched in the processing apparatus 100 according to the method described previously with respect to FIGS. 1-3.

The semiconductor layer 251 may be formed on the substrate 250. A gate insulating layer 252 may be formed on the semiconductor layer 251, so outer surfaces of the semiconductor layer 251 and an upper surface of the substrate 250 may be covered therewith. The gate electrode 253 may be formed on the gate insulating layer 252 in a region corresponding to a channel area of the semiconductor layer 251. An interlayer insulating layer 254 may be formed on the gate electrode 253, so outer surfaces of the gate electrode 253 and an upper surface of the gate insulating layer 252 may be covered therewith. A contact hole 260 may be formed through the gate insulating layer 252 and the interlayer insulating layer 254, followed by formation of source and drain electrodes on the interlayer insulating layer 254.

More specifically, a conductive metal, e.g., silver (Ag) or silver alloy, may be deposited on the interlayer insulating layer 254 and inside the contact hole 260, so the conductive metal, i.e., source and/or drain electrodes 255a and 255b, may be electrically connected to the semiconductor layer 251. Once the conductive layer is deposited, it may be patterned by, e.g., etching in the processing chamber 100, to form the source/drain electrodes 255a and 255b. It should be noted, however, that even though exemplary embodiments of the present invention include etching of the source/drain electrodes 255a and 255b in the processing apparatus 100, other elements of the TFT 200 and/or other processing steps of thin films may be performed in the processing apparatus 100 according to embodiments of the present invention.

The TFT 200 may be an element of a display device, e.g., an electroluminescent (EL) display. For example, referring to FIG. 7, an EL display 300 may include a substrate 310, the TFT 200 on the substrate 310, and a light emitting diode (LED) 370, i.e., a lower electrode 340, a light emitting layer 350, and an upper electrode 360. The LED 370 may be an organic LED, and may be electrically connected to the TFT 200, i.e., the lower electrode 340 may be electrically connected to the drain electrode 255b of the TFT 200 through a via hole in a pixel defining film 330. Since the TFT 200 is formed according to an embodiment of the present invention, i.e., the method described previously with respect to FIGS. 1-3, surfaces of the source/drain electrodes 255a and 255b thereof may be uniformly formed. Accordingly, the electrical connection between the source/drain electrodes 255a and 255b and the lower electrode 340 of the EL device 300 may be improved, thereby improving reliability and operability of the EL device 300.

The lower electrode 340, i.e., anode electrode, of the LED 370 may be patterned by, e.g., a photolithography process, along the pixel defining film 330. The light-emitting layer 350 may be formed on the lower electrode 340, and may include an electron injecting layer (not shown), an electron transporting layer (not shown), a hole injecting layer (not shown), and a hole transporting layer (not shown). The upper electrode 360, i.e., a cathode electrode, may be formed on the light-emitting layer 350. Accordingly, when a predetermined voltage is applied to the lower and upper electrodes 340 and 360 of the LED 370, holes injected from the lower electrode 340 may be transported into a light emission layer of the light-emitting layer 350 via the hole transporting layer. Similarly, electrons injected from the upper electrode 360 may be transported into the light emission layer of the light-emitting layer 350 via the electron transporting layer, so the electrons and the holes may be recombined to generate exitons. As the exitons change from an excitation state to a lower energy state, photons may be emitted from the light-emitting layer 350 to form images.

According to embodiments of the present invention, a process for removing static electricity between a substrate and its holding plate by using argon (Ar) gas may be advantageous in preventing or substantially minimizing damage to thin films formed on the substrate, thereby providing, e.g., TFTs, having a high performance. More specifically, removal of static electricity by using argon gas may prevent or substantially minimize deformation, e.g., expansion, of thin films formed on the substrate, e.g., source/drain electrodes, so that resistance at an interface between the thin films and elements connected thereto, e.g., between the TFT and LED in an EL display, may be reduced. It should be further noted that although an embodiment of the present invention was described with reference to source/drain electrodes of an EL display formed of silver or silver alloy, other types of display device, e.g., a liquid crystal display(LCD), a field emission display (FED), a plasma display panel (PDP), an organic light emitting display (OLED), a vacuum fluorescent display (VFD), and so forth, and/or other types of thin films are within the scope of the present invention

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for removing static electricity from a first plate in a processing chamber including a substrate on the first plate and a second plate opposite the first plate, the method comprising:
generating static electricity in the first plate to adhere the substrate to the first plate; and
supplying argon gas into the processing chamber to remove the static electricity.

2. The method as claimed in claim 1, further comprising processing the substrate on the first plate.

3. The method as claimed in claim 2, wherein processing the substrate on the first plate includes forming at least one thin film thereon.

4. The method as claimed in claim 3, wherein forming the thin film includes depositing silver or silver alloy on the substrate.

5. The method as claimed in claim 3, wherein processing the substrate on the first plate further includes etching the thin film by using plasma.

6. The method as claimed in claim 2, wherein processing the substrate on the first plate includes forming silver or silver alloy electrodes thereon.

7. The method as claimed in claim 1, wherein generating static electricity includes applying voltage to the first plate

8. The method as claimed in claim 7, further comprising disconnecting the voltage from the first plate before supplying the argon gas.

9. The method as claimed in claim 1, wherein generating static electricity includes using an electrostatic chuck as a first plate.

10. The method as claimed in claim 1, further comprising detaching the substrate from the first plate by raising a lift pin through the first plate after removing the static electricity from the first plate.

11. The as claimed in claim 1, further comprising removing the substrate from the processing chamber after removing the static electricity from the first plate.
